(19) United States
(12) Patent Application Publication
(10) Pub. No.: US 2012/0046083 A1
(43) Pub. Date: Feb. 23, 2012

(54) Cell phone holder

(76) Inventor: Keven H. Klett, Huntington Beach, CA (US)

(21) Appl. No.: 13/134,586

(22) Filed: Jun. 10, 2011

Related U.S. Application Data
(60) Provisional application No. 61/399,270, filed on Jul. 8, 2010.

(51) Int. Cl. H04M 1/00

(52) U.S. Cl. 455/569.1; 455/575.6

(57) ABSTRACT

A cell phone holder suitable for use in supporting an operating cell phone in a hands-free use by a vehicle driver includes an elongated flexible body supporting a weight at one end and a cell phone receptacle at the other end. A cell phone operating in the speaker mode is inserted into the cell phone receptacle. The cell phone holder thus formed is placed upon the driver's shoulder such that the flexible body passes over the user's shoulder and downwardly at its weighted end on the rear shoulder of the user. The forward end supporting the cell phone within the cell phone receptacle extends downwardly over the front shoulder and upper chest of the user enabling the user to hear the cell phone audio output and to speak into the speaker phone microphone of the cell phone.

### CROSS-REFERENCE TO RELATED APPLICATION

This application claims the benefit of and priority under 35 U.S.C. 119(e) of U.S. Provisional Patent Application No. 61/399,270 entitled CELL PHONE HOLDER filed Jul. 8, 2010 in the name of Keven H. Klett, the disclosure of which is incorporated herein by reference.

### FIELD OF THE INVENTION

This invention relates generally to cell phones and particularly to apparatus for providing hands-free use thereof.

### BACKGROUND OF THE INVENTION

The rapid expansion of cell phone use has virtually revolutionized the telephone industry. Cell phones have become pervasive and have increased dramatically in capabilities and applications. From the earliest development of cell phone, one of the more common uses of cell phones was experienced by vehicle drivers. The convenience of being able to make and maintain telephone conversations while driving a vehicle quickly became the norm within telephone communication. As the proliferation of cell phones continued to expand dramatically, the number of drivers experiencing difficulties and accidents as the result of the distraction provided by cell phone use in a vehicle also increased in dramatic numbers. The number of vehicle accidents and mishaps attributed to the distraction of cell phone use while operating vehicles prompted lawmakers in many jurisdictions to mandate a “hands-free” capability for cell phone use while driving a vehicle. In some sense, the term hands-free is a misnomer in that a complete hands-free operation is not mandated. Most laws require that the user be capable of indulging in and maintaining a cell phone conversation without the need to hold the cell phone in the user's hand.

To meet the need for hands-free operation by vehicle drivers, practitioners in the art have provided several types of devices. The lowest cost and most prevalent apparatus provided for hands-free cell phone use typically comprises a small plug-in earphone and microphone combination together with a connecting wire which plugs into the cell phone external input jack. Other devices have been provided which take a more sophisticated approach and which generally comprise a small ear mounted device having a speaker and microphone together with an electronic communication link to the basic cell phone. Thus, the user is able to avoid the need for a tethered connection to the cell phone and enjoys greater freedom of movement within the vehicle.

While both the foregoing types of hands-free devices have, to some extent, met this need, they tend to be cumbersome and uncomfortable to use and have been met with some dissatisfaction on the part of cell phone users.

In view of the shortcomings of presently available hands-free apparatus for cell phone use by vehicle drivers, there arises a need in the art for an improved cell phone apparatus which meets the hands-free requirements mandated by law and which is low in cost and easy to use. There remains a further need for a hands-free device which is more comfortable and less intrusive upon the vehicle driver than present day hands-free devices.

### SUMMARY OF THE INVENTION

Accordingly, it is a general object of the present invention to provide an improved cell phone holder which operates a conventional speaker phone enabled cell phone in a hands-free vehicle driving environment. It is a particular object of the present invention to provide a hands-free operative cell phone holder which does not require wire connection to the cell phone.

The present invention cell phone holder provides a flexible cell phone receptacle which receives and supports a cell phone within a cell phone pocket. The receptacle further includes an extending flexible strap which terminates in a counterweight at its extreme end. In typical use, the cell phone is placed within the receptacle within the cell phone holder and the combination of cell phone and cell phone holder is placed upon the user's chest and shoulder with the strap passing over the user's shoulder to position the counterweight upon the user's back. The cell phone holder maintains the cell phone in proximity to the user's mouth and ear without the need for further attachment. The cell phone within the receptacle is operated in its “speaker” mode allowing the user to speak into the cell phone microphone and listen to the other party via the speaker feature of the cell phone. The entire cell phone holder is simple and low costs while maintaining excellent hands-free use of the driver's cell phone. In its preferred use, the cell phone holder supporting a cell phone is positioned on the inside shoulder and chest of the driver to avoid interference with the seatbelts of the vehicle.

More specifically, the present invention provides for use in combination with a cell phone for operation in a hands-free mode, a cell phone holder comprising: an elongated flexible body having first and second ends; a weight supported by the first end; and a cell phone receiving receptacle formed on the second end, the cell phone holder constructed to be placed upon a user's shoulder such that the first end lays against the user's rear shoulder and the second end, supporting a cell phone in the cell phone receiving receptacle, lays against the user's front shoulder.

### BRIEF DESCRIPTION OF THE DRAWINGS

The features of the present invention, which are believed to be novel, are set forth with particularity in the appended claims. The invention, together with further objects and advantages thereof, may best be understood by reference to the following description taken in conjunction with the accompanying drawings, in the several figures of which like reference numerals identify like elements and in which:

FIG. 1 sets forth a perspective view of a typical vehicle driver utilizing a cell phone holder constructed in accordance with the present invention;

FIG. 2 sets forth an enlarged partial perspective view of a typical driver utilizing the present invention cell phone holder;

FIG. 3 sets forth a partially sectioned front view of the present invention cell phone holder;

FIG. 4 sets forth a side elevation view of the present invention cell phone holder;

FIG. 5 sets forth a partial perspective view of an alternate embodiment of the present invention cell phone holder;

FIG. 6 sets forth a perspective view of a still further alternate embodiment of the present invention cell phone holder;

FIG. 7 sets forth a partially sectioned front view of a further alternate embodiment of the present invention cell phone holder;

FIG. 8 sets forth a rear view of the present invention cell phone holder shown in FIG. 7; and

FIG. 9 sets forth a partial section front view of the embodiment of FIG. 7 supporting a typical cell phone.

### DESCRIPTION OF THE PREFERRED EMBODIMENTS

By way of overview, the present invention cell phone holder provides an elongated generally elongated flexible base member having a cell phone receiving pocket or receptacle on one end and a counterweight on the opposite end. The cell phone receptacle is configured to receive the partial insertion of a typical cell phone such that the upper portion of the cell phone extends beyond the upper edge of the cell phone receptacle. The receptacle or pocket portion of the present invention cell phone holder preferably defines a plurality of apertures therein suitable for passing sound energy. The counterweight is sufficient to balance the anticipated combined weight of the cell phone receptacle portion and a typical cell phone therein. The strap portion extending between the counterweight and the cell phone receptacle portion is preferably formed of a flexible material. In an anticipated use of the present invention, the user having an operative cell phone positioned within the cell phone receptacle of the present invention holder places the cell phone and receptacle high on the user's chest near the shoulder and neck of the user such that the flexible strap extends rearwardly over the user's shoulder and downwardly upon the upper portion of the user's back such that the counterweight is positioned upon the user's back. In this position, the cell phone is maintained proximate to the user's mouth and ear enabling the user to speak into the microphone of the cell phone and to hear audio output from the speaker portion of the cell phone. The user is able to maintain undivided attention to driving activities and is able to speak to and listen to the cell phone conversation without moving from an eyes forward head position.

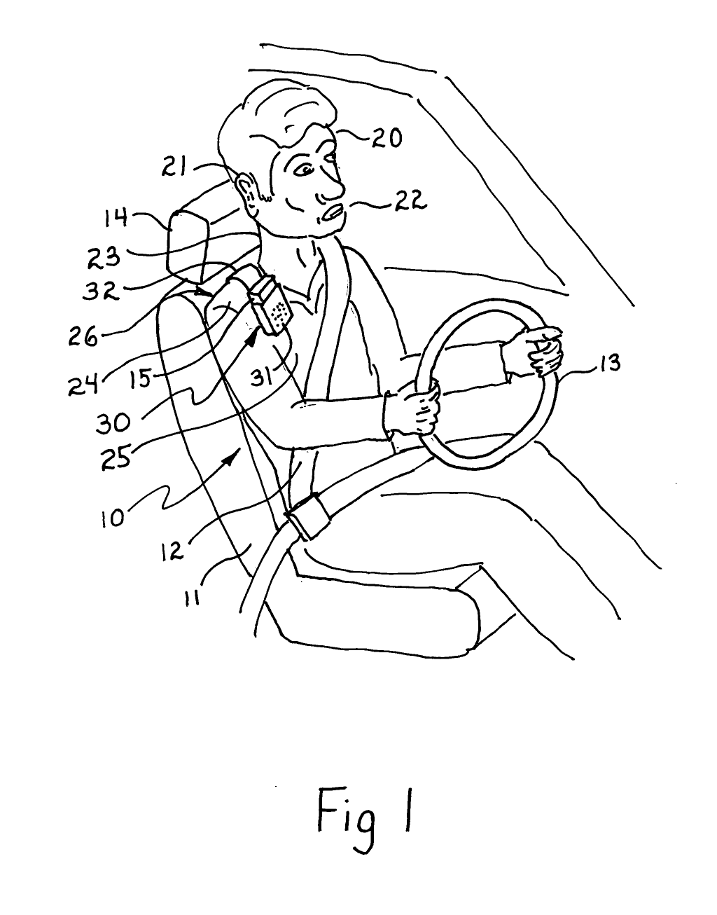

More specifically and with reference to FIG. 1, a typical driver 10 is shown seated upon a conventional vehicle seat 11 in the driver's position such that driver 10 is able to grip steering wheel 13 of the host vehicle. A conventional seatbelt 12 is shown securing driver 10 within seat 11 also in accordance with conventional vehicle fabrication. Seat 11 includes a head rest 14 on the upper portion thereof. Driver 10 is seated upon seat 11 and secured by seatbelt 12 such that driver's head 20 is positioned against headrest 14 and such that driver 10 is able to face forwardly within the host vehicle and participate in driving activities.

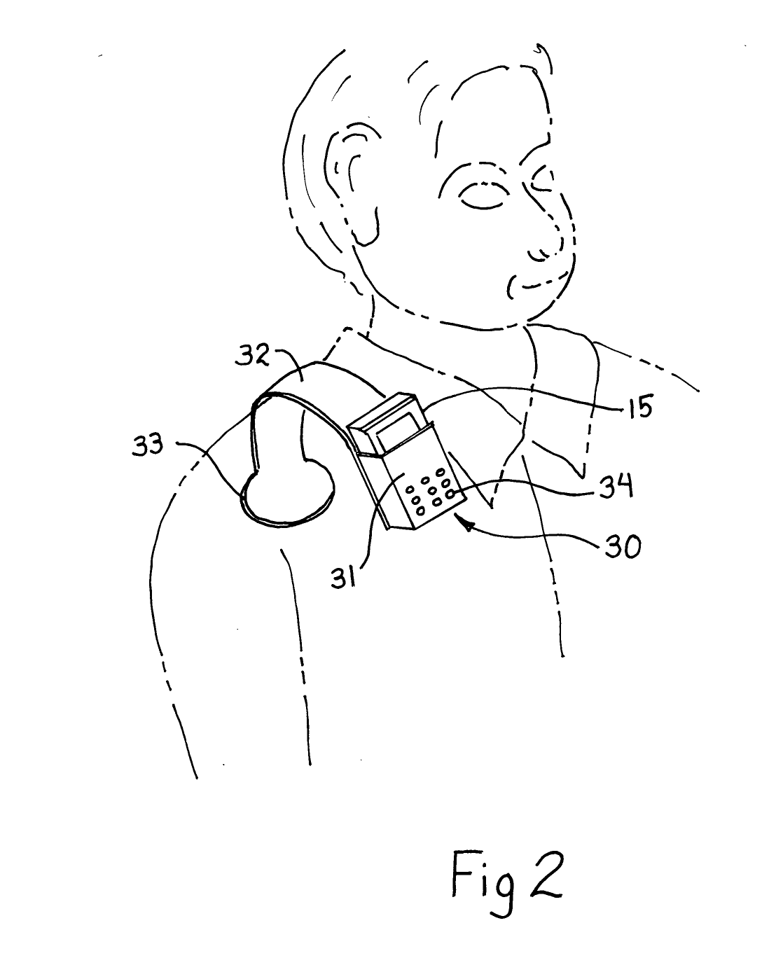

In accordance with the present invention, a cell phone holder 30 includes a cell phone receptacle 31, a strap 32 and a counterweight 33 (counterweight 33 shown in FIG. 2). In further accordance with the present invention, cell phone receptacle 31 receives a conventional cell phone 15 and is supported thereby. In the anticipated use of the present invention cell phone holder, cell phone receptacle 31 supporting cell phone 15 is positioned upon chest 25 of driver 10 such that strap 32 passes over shoulder 24 of driver 10. As is better seen in FIG. 2, strap 32 passes downwardly from shoulder 24 allowing counterweight 33 to rest upon the user's back.

With cell phone 15 retained with cell phone holder 30 in the manner shown in FIG. 1, cell phone 15 operated in the speaker mode is positioned close to mouth 22 and ear 21 upon head 20 of driver 10. With cell phone 15 positioned and maintained in this manner, speech from driver 20 is readily received by the microphone (not shown) within cell phone 15. Similarly, with cell phone 15 retained as shown in FIG. 1, audio output from cell phone 15 is readily heard by ear 21 of driver 20.

Thus, in accordance with an important aspect of the present invention, cell phone holder 30 maintains cell phone 15 in close proximity to mouth 22 and ear 21 of driver 10 in a hands-free operation. In further accordance with the present invention, cell phone holder 30 maintains the operative position of cell phone 15 without the need for a wire tether or wireless connection of the type utilized by prior art cell phone devices. In the preferred use of the present invention cell phone holder, the user typically prefers to utilize cell phone holder 30 upon the right shoulder to avoid interference with seat belt 12 which typically passes over the user's left shoulder.

FIG. 2 sets forth an enlarged perspective view of the present invention cell phone holder upon the user's right shoulder in which the user is depicted in phantom-line drawing to facilitate complete illustration of the entire cell phone holder. More specifically, FIG. 2 shows a cell phone holder 30 constructed in accordance with the present invention having a cell phone receptacle 31 forming a pocket within which a conventional cell phone 15 is received and secured. Cell phone holder 30 further includes a flexible strap 32 passing over the user's shoulder and terminating in a counterweight 33. The passage of strap 32 over the user's shoulder positions counterweight 33 against the user's upper back while maintaining cell phone receptacle 31 and cell phone 15 upon the upper front chest of the user. Of importance with respect to the present invention is the positioning of cell phone holder such that cell phone 15 is maintained in close proximity to the ear and mouth of the cell phone user. This facilitates the speaker phone communication between the user and cell phone 15.

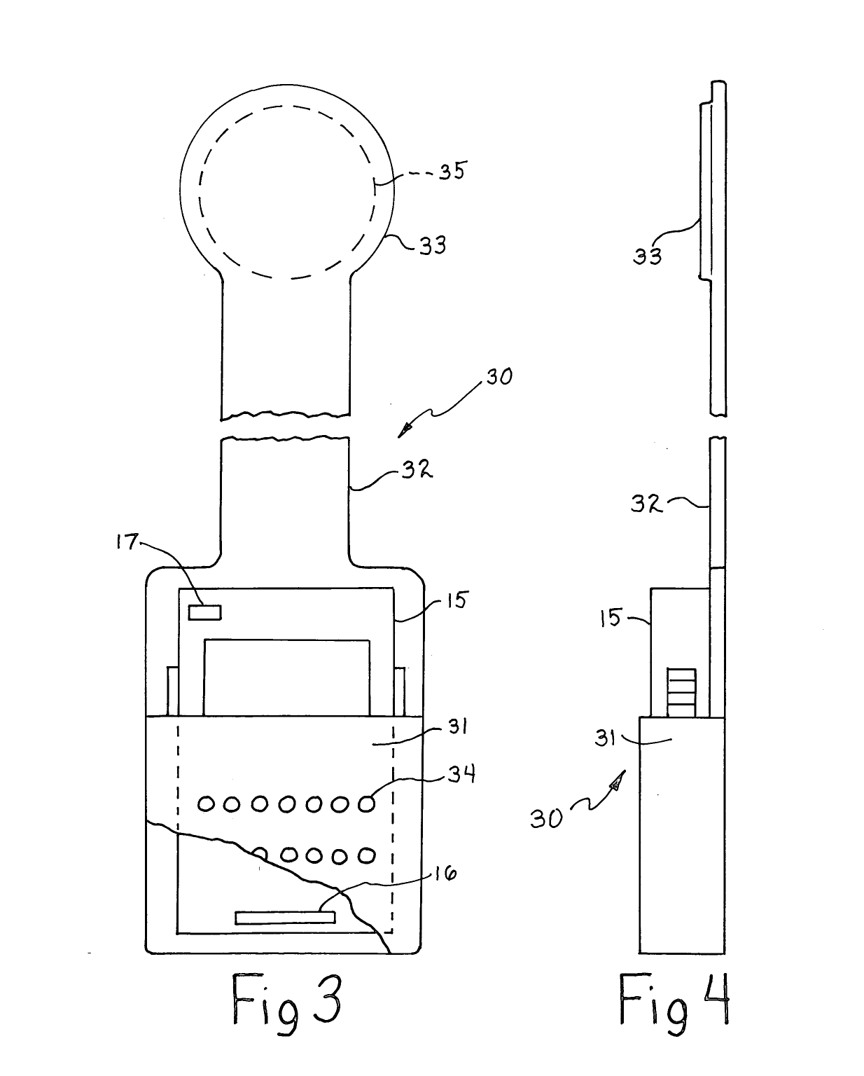

FIG. 3 sets forth a partially sectioned front view of cell phone holder 30 constructed in accordance with the present invention. Cell phone holder 30 as described above includes a cell phone receptacle 31 configured to receive and support a conventional cell phone 15. Receptacle 31 defines a plurality of apertures 34 suitable for allowing sound energy to pass to and from cell phone 15. Cell phone holder 30 further includes a strap 32 extending from cell phone receptacle 31 and terminating in a counterweight 33. Counterweight 33 may be fabricated in virtually any convenient fabrication suitable for providing sufficient counterweight to generally balance the weight of cell phone 15 and receptacle 31. For example, counterweight 33 may comprise a conventional metal washer or metal disk 35. Cell phone 15 will be understood to be illustrative of a variety of conventional cell phones in which the microphones and speakers thereof are variously positioned upon the cell phone body. For purposes of illustration, cell phone 15 is shown having a microphone 16 on its upper portion and a speaker 17 on its lower portion. It will understood by those skilled in the art, however, that virtually any conventional cell phone may be utilized within receptacle 31 so long as it is capable of being operated in speaker phone mode.

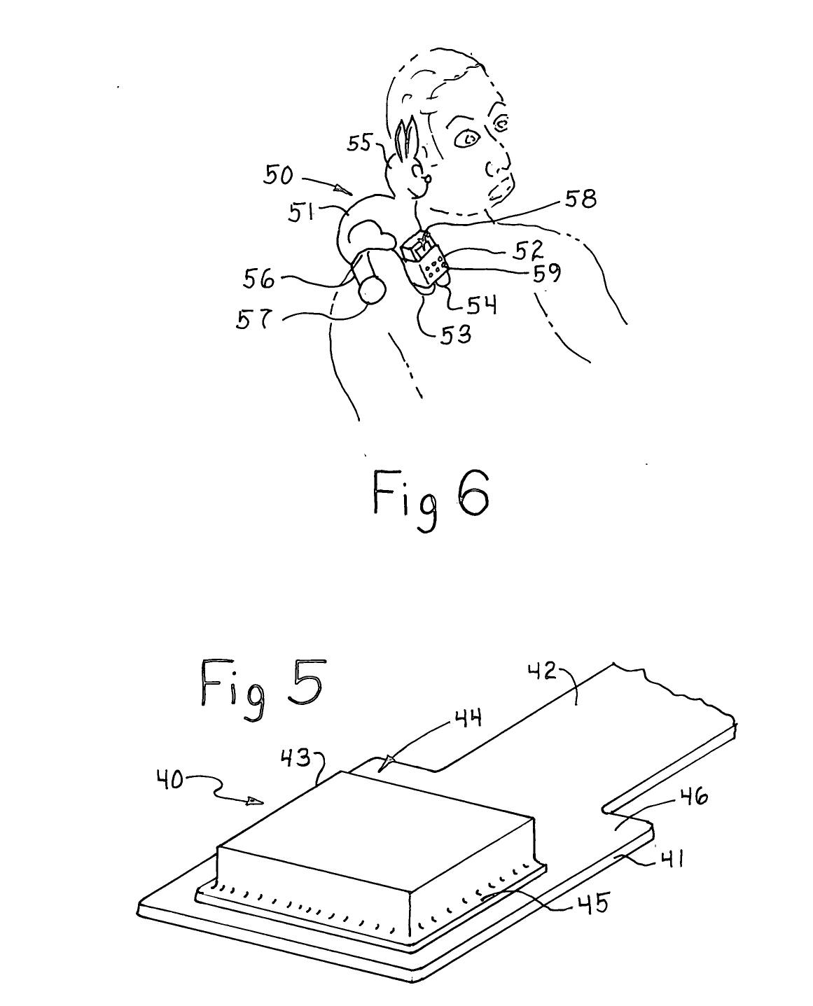

FIG. 4 sets forth a side elevation view of cell phone holder 30 which as described above includes a cell phone receptacle 31 together with a strap 32 extending therefrom. Cell phone receptacle 31 further includes a counterweight 33 at the extreme end of strap 32. As is also described above, receptacle 31 receives a conventional cell phone 15.

It will be apparent to those skilled in the art that the present invention cell phone holder may be fabricated using a variety of different materials. Thus, for example, cell phone holder 30 may be fabricated of generally flexible plastic material such as vinyl material or the like. Additionally, cell phone holder 30 may be fabricated of other materials such as cloth or leather without departing from the spirit and scope of the present invention. By way of further example, it will be apparent to those skilled in the art that cell phone receptacle 31 may be formed by attachment to strap 32 using a variety of attachments such as chemical or sonic welding, adhesive attachment, or mechanical fasteners such as sewn stitching or metal fasteners such as rivets or the like. The important aspect in fabricating cell phone holder 30 is the provision of a suitable receptacle for receiving and securing a cell phone therein. It will be further apparent to those skilled in the art that while the preferred fabrication of the present invention cell phone holder utilizes a flexible material for strap 32, in certain instances users may prefer a strap having memory such as a flexible deformable metal material or the like. In this use, strap 32 may be pre-bent to a generally U-shaped form to fit upon the user's shoulder. In either event, the important aspect of the fabrication of the present invention cell phone holder is the secure positioning of the cell phone upon the user's upper chest area near the user's mouth and ear.

FIG. 5 sets forth a partial perspective view showing one form of attachment of receptacle 31 to the body of strap 32. Once again, it will be understood that a variety of different fabrications may be utilized without departing from the spirit and scope of the present invention.

More specifically, FIG. 5 sets forth a plastic or vinyl material embodiment of the present invention generally referenced by numeral 40. The specific fabrication of cell phone 40 shown in FIG. 5 utilizes a laminar plastic or vinyl material. However, other materials such as leather or fabric may be used without departing from the spirit and scope of the present invention. Thus, cell phone holder 40 includes a generally rectangular base 41 which comprises the lower end of strap 42 and which is preferably formed integrally therewith. Thus, base 41 forms the bottom end of strap 42. Base 41 further defines an upper surface 46. A cell phone receptacle 43 is formed to define an internal upwardly open pocket 44. Receptacle 43 is formed of a planar material and is configured to provide a three-sided lip 45 extending around the sides and bottom of the receptacle. In accordance with the preferred fabrication of the present invention, lip 45 is joined to surface 46 of base 41 using conventional attachment such as heat or sonic welding, adhesive bonding, or mechanical attachment such as sewn stitches or mechanical fasteners such as rivets or the like. The important aspect of the apparatus used to join lip 45 to surface 46 is the provision of a convenient easily manufactured attachment of sufficient strength to maintain the integrity of pocket 44.

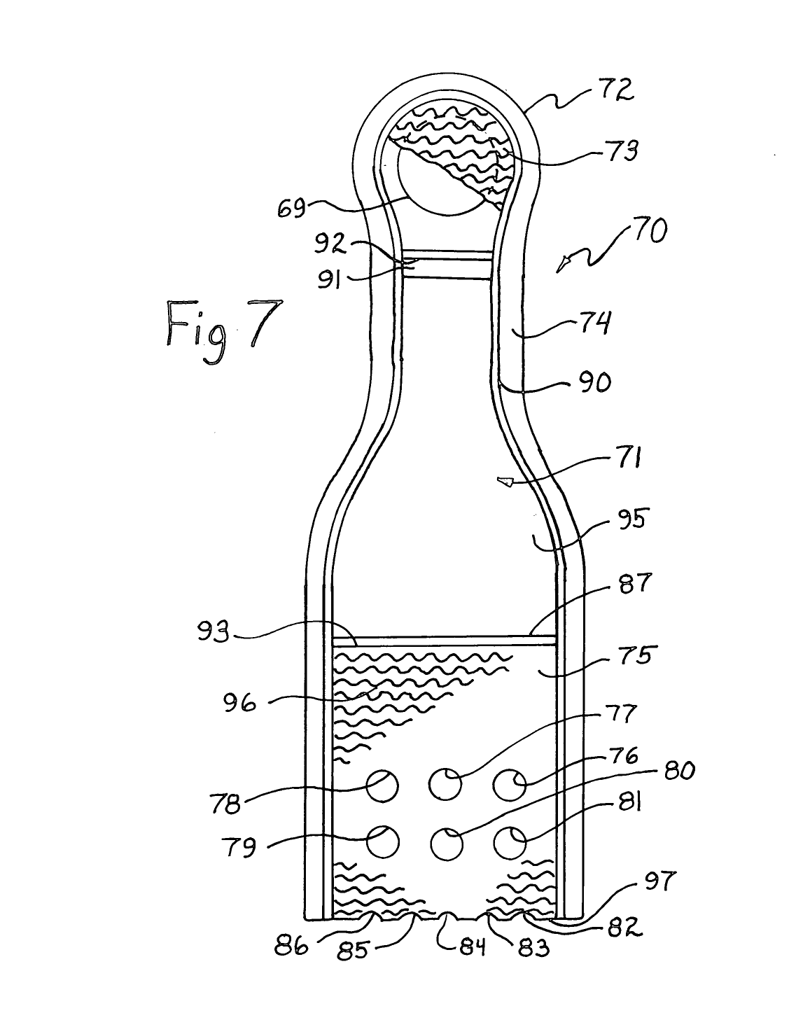

FIG. 6 sets forth a perspective view of an alternate embodiment of the present invention cell phone holder generally referenced by numeral 50. Cell phone holder 50 is configured to represent a plush body FIG. 51 having a fanciful animal-like appearance and structure. Figure body 51 includes a head 55, a tail 56 and front paws 53 and 54. Tail 56 further supports a counterweight 57 while front paws 53 and 54 define a cell phone receptacle 52. Cell phone receptacle 52 forms a cell phone receiving pocket 58 within which a conventional cell phone 15 is received. Cell phone receptacle 52 further defines a plurality of apertures 59 suitably configure to allow sound energy to pass to and from receptacle 52.

Cell phone holder 50 provides a novelty like and fanciful cell phone holder which nonetheless functions in accordance with the present invention to maintain the position of cell phone 15 in proximity to the mouth and ear of the cell phone user. The fanciful depiction of figure body 51 may be designed to provide different appearance novelty items such as different animals, figures or other fanciful creations. The operation and function of cell phone holder 50 remains the same as the above-described embodiments in which the cell phone holder passes over the user's shoulder to support cell phone 15 upon the upper chest of the user near the user's mouth and ear. The operation of cell phone holder 50 further utilizes counterweight 57 extending from and supported by tail 56 of figure body 51.

FIG. 7 sets forth a planar view of an alternate embodiment of the present invention cell phone holder generally referenced by numeral 70. Cell phone holder 70 functions in substantially the same manner as the above-described inventive cell phone holders and is preferably fabricated of a material having a textured side and a smooth side with the textured side tending to be non-slip or grip-type material. In its preferred form, the material selected for cell phone holder 70 is substantially flexible and “limp” in its character. It will be recognized, however, that the material used to fabricated cell phone 70 may be selected to have a stiffer characteristic or memory material in certain applications.

More specifically, cell phone holder 70 includes an elongated flexible body 71 fabricated of a material having a smooth side 95 and a non-slip side 96. While a variety of materials may be utilized in practicing the invention set forth in cell phone holder 70, particular advantage has been found in utilizing a material known in the plastic and textile arts as expanded supported vinyl or polyvinyl chloride, also known as PVC. It will be recognized however that other suitable materials may be utilized without departing from the spirit and scope of the present invention. Body 71 preferably comprises an elongated single fabric member which is folded upwardly along a fold line 97 to form a cell phone receptacle 75. The upper portion of receptacle 75 is sewn along a stitch line 93 to form a convenient edge for a cell phone receptacle 87 formed between the overlapping portions of body 71. Fold line 97 defines a plurality of vent apertures 82, 83, 84, 85 and 86 along fold line 97. In addition, receptacle 75 further defines a plurality of apertures 76 through 81 on the frontal portion thereof.

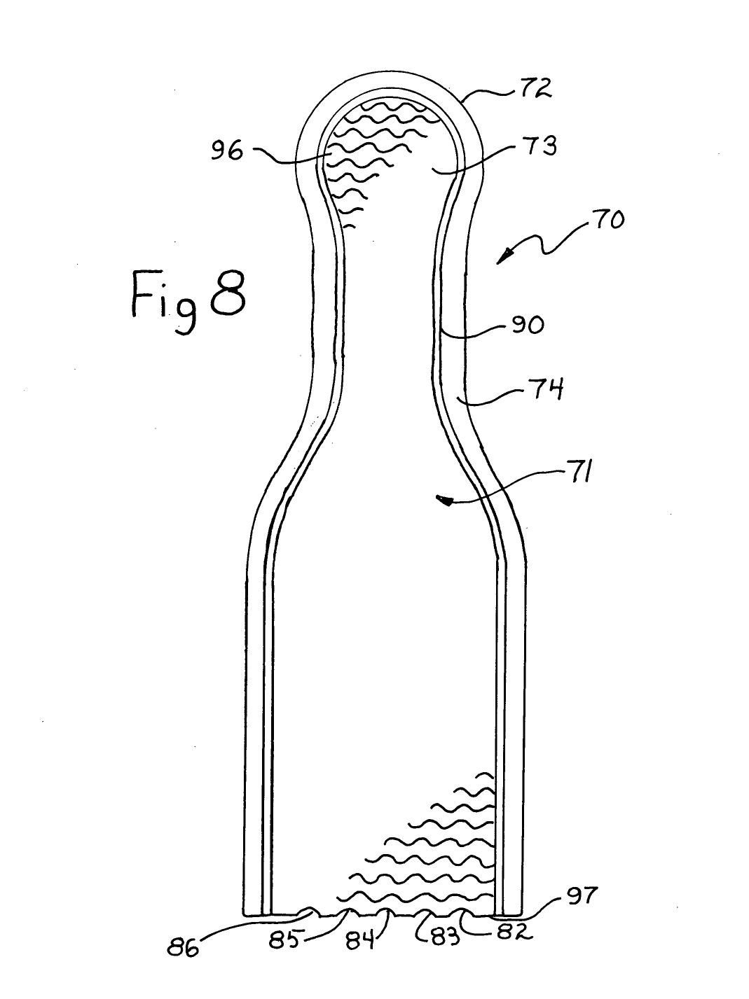

As mentioned above, body 71 is preferably formed of a material having a non-slip surface on one side and a smooth surface on the other. Accordingly, body 71 is fabricated such that non-slip side 96 is exposed forwardly on receptacle 75 and, as is better seen in FIG. 8, covers virtually the entire rear surface of flexible body 71. Flexible body 71 further includes a generally circular upper end 72 having a weight pocket 73 formed therein. Weight pocket 73 is formed by overlying upper end 72 with an additional layer of fabric having its non-slip side exposed. Within weight pocket 73, a generally disk-shaped weight 69 preferably formed of a heavy material such as metal or the like is captivated. Weight pocket 73 is completed by a pocket binding 91 which closes the lower end of weight pocket 73 which in turn is completed by a sewn stitch line 92. Thus, weight 69 is captivated within weight pocket 73 to add weight to end 72.

Finally, cell phone holder 70 is completed by wrapping a generally continuous fabric binding 74 upon the overlapping edges of weight receptacle 75 and upwardly on the edges of body 71 and encircling weight pocket 73. Binding 74 is formed of a suitable flexible material such as cloth or the like and is secured by a generally continuous sewn stitch indicated by stitch line 90.

FIG. 8 sets forth a rear view of cell phone holder 70 showing the reverse side of flexible body 71. As mentioned above, flexible body 71 is covered on its rear surface in its entirety with non-slip material preferably formed in the above-described expanded supported vinyl or PVC fabrication. However, suffice it to note that in the preferred fabrication of cell phone 70, the entire rear surface of body 71 is covered in non-slip material. For purposes of illustration, FIG. 8 shows a portion of body 71 bearing non-slip texture. However, to avoid unduly cluttering FIG. 8, the remaining portions of body 71 are not shown bearing the above-described non-slip texture but will be understood to be covered completely on the entire rear surface thereof. Once again as described above, the outer edges of body 71 are secured by a suitable cloth binding 74 which in turn is secured by a sewn seam indicated by stitch line 90.

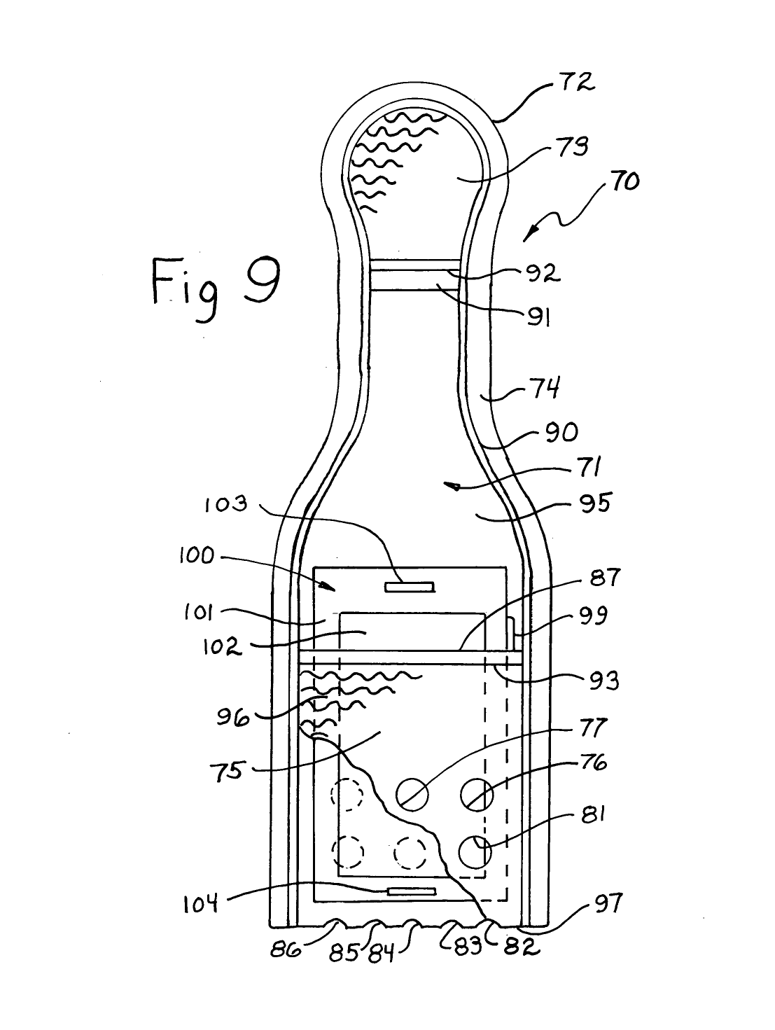

FIG. 9 sets forth a partially sectioned front view of cell phone holder 70 supporting a typical cell phone generally referenced by numeral 100. Cell phone 100 will be understood to be representative of cell phones generally rather than a particular type. Accordingly, it will be apparent to those skilled in the art that virtually any cell phone may be positioned within cell phone receptacle 75 in the general manner shown in FIG. 9. By way of further generality, it will be understood that the manner in which a cell phone is inserted into cell phone receptacle 75 of cell phone holder 70 is determined in large part by the type of phone to be utilized. Phones may be positioned within receptacle 75 in either a forward looking relationship as shown in FIG. 9 or, alternatively, may be reversed to be positioned with the rear face extending forwardly within receptacle 75. By way of further generalization, it will be recognized that so-called “flip” type cell phones characterized by a hinged frontal cover may be positioned within receptacle 75 in the open configuration with the flip cover extending upwardly without departing from the spirit and scope of the present invention.

As described above, cell phone holder 70 includes an elongated body 71 preferably formed of a fabric material having a non-slip side 96 and a smooth side 95. As is also described above, elongated body 71 is folded upwardly along a fold line 97 to overlap the lower portion of flexible body 71 and form a cell phone receptacle 75. Cell phone receptacle 75 defines a receptacle mouth 87 formed by the upper edge of receptacle 75. A portion of the upper edge of receptacle 75 is folded downwardly and secured by a sewn seam indicated by stitch line 93 to provide an easily used receptacle mouth edge. Receptacle 75 further defines a plurality of vent apertures 82 through 86 along fold line 97 and a plurality of apertures 76 through 81 (apertures 78, 79 and 80 shown in FIG. 7).

As is also described above, flexible body 71 terminates at its upper end in a weight pocket 73 formed by an overlying second layer of fabric material which is secured along the bottom edge thereof with a binding 91 sewn in place by a sewn seam indicated by stitch line 92. A weight 69 preferably formed of a heavy material such as metal or the like is captivated within weight pocket 73. Finally, as is also described above, cell phone holder 70 is completed by a binding 74 which captivates the edges of flexible body 71 and is formed of a suitable fabric material. Binding 74 is secured by a sewn seam indicated by stitch line 90.

As mentioned above, a typical cell phone 100 is shown positioned within cell phone receptacle 75. Cell phone 100 is representative of general cell phone construction and includes a front surface 101 having a display screen 102 supported thereon. Cell phone 100 further includes a microphone 103 on the upper edge thereof and a speaker 104 at the lower edge thereof. It will be understood that, in accordance with different fabrications for cell phones, the locations of microphone 103 and speaker 104 may be positioned at different places upon cell phone 100. Cell phone 100 also includes a speaker mode button 99 which in accordance with conventional cell phone fabrication techniques is utilized to engage the operation of cell phone 100 in its “speaker mode”. Speaker mode is well known in cell phone fabrication and is characterized by being operated much like a conventional cell phone without the need to place the phone directly against the ear and mouth for use. Cell phone holder 70 functions once cell phone 100 is positioned within receptacle 75 and speaker button 99 is employed to configure cell phone 100 in its speaker mode by utilization of the above-described method as shown above in FIGS. 1 and 2. Accordingly, cell phone holder 70 supporting cell phone 100 is utilized by positioning receptacle 75 and cell phone 100 upon the front shoulder area as indicated in FIGS. 1 and 2 above while allowing flexible body 71 to pass over the user's shoulder and allowing end 72 supporting weight 69 to extend downwardly on the rear shoulder of the user. In this manner, cell phone holder 70 retains cell phone 100 in an ideal position for “hands-free” operation as the user drives a vehicle or engages in other hands-free activity. It will be understood by those skilled in the art that the positioning of non-stick surface material upon the entire rear portion of flexible body 71 in the manner shown in FIG. 8 greatly enhances the tendency of cell phone holder 70 to secure and maintain cell phone 100 in the desired front shoulder/chest position of the user.

While it is recognized that different stiffnesses of flexible body 71 may be utilized without departing from the spirit and scope of the present invention, it has been found that utilizing extremely flexible “limp” material rather than formable memory type material is for the most part advantageous in operation of the present invention cell phone holder and the cell phone supported therein.

What has been shown is a novel cell phone holder suitable for providing hands-free operation of a cell phone by a vehicle driver which is simple to use and which is low in manufacturing costs and complexity. The inventive cell phone holder shown avoids the need for electronic communication apparatus and also avoids the need for tether or other connection between the cell phone user and the cell phone. The cell phone holder shown readily employs virtually any conventional cell phone so long as the cell phone is capable of speaker phone operation.

While particular embodiments of the invention have been shown and described, it will be obvious to those skilled in the art that changes and modifications may be made without departing from the invention in its broader aspects. Therefore, the aim in the appended claims is to cover all such changes and modifications as fall within the true spirit and scope of the invention.

That which is claimed is:

1. For use in combination with a cell phone for operation in a hands-free mode, a cell phone holder comprising:
an elongated flexible body having first and second ends;
a weight supported by said first end; and
a cell phone receiving receptacle formed on said second end,
said cell phone holder constructed to be placed upon a user's shoulder such that said first end lays against the user's rear shoulder and said second end, supporting a cell phone in said cell phone receiving receptacle, lays against the user's front shoulder.

2. The cell phone holder set forth in claim 1 wherein said flexible body includes a rear surface supporting a non-slip texture.

3. The cell phone holder set forth in claim 2 wherein said cell phone receiving receptacle defines a plurality of vent apertures.

4. The cell phone holder set forth in claim 1 wherein said flexible body further includes a novelty item.

5. The cell phone holder set forth in claim 4 wherein said novelty item defines an animal-like appearance.

6. The cell phone holder set forth in claim 4 wherein said flexible body includes a rear surface supporting a non-slip texture.

7. The cell phone holder set forth in claim 6 wherein said cell phone receiving receptacle defines a plurality of vent apertures.

8. A cell phone holder comprising:
a weighted end constructed to lay against the rear shoulder of a user;
a receptacle end constructed to receive and support a cell phone against the front shoulder of a user; and
a flexible body joined to said weighted end and said receptacle end, said flexible end constructed to lay upon a user's shoulder and to support said weighted end against the rear shoulder of a user and to support said receptacle end against the front shoulder of a user.

9. The cell phone holder set forth in claim 8 wherein said flexible body defines a shoulder-contacting surface formed of a non-slip material.

10. The cell phone holder set forth in claim 9 wherein said receptacle end defines a front shoulder-contacting surface formed of a non-slip material.

11. The cell phone holder set forth in claim 10 wherein said weighted end defines a rear shoulder-contacting surface formed of a non-slip material.

12. The cell phone holder set forth in claim 11 wherein said weighted end includes a weight receptacle and a weight captivated therein.

13. A cell phone holder comprising:
an elongated flexible body having a first surface, a second surface, a first end, a second end and an outer edge;
a cell phone receptacle formed by folding a portion of said second end upwardly and joining said outer edges thereof; and
a weight secured to said first end.

14. The cell phone holder set forth in claim 13 wherein said second surface supports a non-slip texture and wherein said folded portion of said second end is folded to overlie said first surface within said cell phone receptacle.

15. The cell phone holder set forth in claim 14 wherein said first end includes a closed pocket captivating said weight therein.
